(19) United States
(12) Patent Application Publication
(10) Pub. No.: US 2014/0175040 A1
(43) Pub. Date: Jun. 26, 2014

(54) Construction Machinery

(71) Applicant: Hitachi Sumitomo Heavy Industries Construction Crane Co., Ltd., Tokyo (JP)

(72) Inventor: Kazunori YAMAMOTO, Obu-shi (JP)

(73) Assignee: Hitachi Sumitomo Heavy Industries Construction Crane Co., Ltd., Tokyo (JP)

(21) Appl. No.: 14/101,946

(22) Filed: Dec. 10, 2013

(30) Foreign Application Priority Data
Dec. 11, 2012 (JP) 2012-270487

(51) Int. Cl. B66C 23/42

(52) U.S. Cl. CPC B66C 23/42
USPC 212/299

(57) ABSTRACT

A lower spreader of a construction machinery has a width smaller than a width of the front leg member; and a plurality of lower sheaves at the lower spreader includes at least; a first lower sheave at which the derricking rope let out from the derricking drum is first wound; a second lower sheave, disposed on a side where a fixed end of the derricking rope at which the derricking rope is fastened is located, at which the derricking rope is wound last; and a third lower sheave, disposed between the first lower sheave and the second lower sheave or at a position adjacent to either the first lower sheave or the second lower sheave, at which the derricking rope, running from an upper sheave among the plurality of upper sheaves at the upper spreader is wound so as to run toward another upper sheave at the upper spreader.

### INCORPORATION BY REFERENCE

The disclosures of the following priority application and publication are herein incorporated by reference: Japanese patent application No. 2012-270487 filed Dec. 11, 2012 and Japanese laid open patent publication No. 2011-190083.

### BACKGROUND OF THE INVENTION

1. Field of the Invention

The present invention relates to a construction machinery.

2. Description of Related Art

A construction machinery known in the related art, such as a crane, includes a gantry foldably mounted at the main frame, a pair of vertical sheaves disposed at an axle at the top of a hanger rotatably disposed at the axle, at which a plurality of horizontal sheaves are disposed and a spreader (may be otherwise referred to as a bridle) that includes a plurality of horizontal sheaves around which a derricking rope running between the hanger and the spreader, is wound. One vertical sheave in the pair of vertical sheaves mounted at the axle at the gantry is disposed on the side where the derricking rope is wound on a derricking drum, and the other vertical sheave is disposed on the side where the fixed end of the derricking rope is located. The derricking rope is wound a plurality of times between the plurality of horizontal sheaves disposed at the hanger and vertical sheaves disposed at the spreader.

In this type of crane, the derricking rope is taken up by causing the derricking drum to rotate and an upper spreader is pulled toward the gantry via the horizontal sheaves at the hanger. As a result, a boom is raised via a pendant rope fastened to the upper spreader, as disclosed in Japanese laid open patent publication No. 2008-195497.

### SUMMARY OF THE INVENTION

In the crane in the related art described above, a plurality of horizontal sheaves are disposed at the hanger and thus, a dimension of the hanger measured along the width of the crane body, is determined to be; the diameter of the horizontal sheaves×the number of horizontal sheaves. For this reason, the width of the gantry in the crane in the related art with the hanger rotatably disposed at the gantry is bound to be significant.

A construction machinery according to a first aspect of the present invention comprises: a derricking drum disposed at a main frame; a gantry that includes a front leg member, a lower spreader laterally disposed at an upper end of the front leg member with a plurality of lower sheaves axially supported at a support shaft, and a rear leg member with an upper end of the rear leg member linked to the support shaft, and is foldably disposed at the main frame; and an upper spreader that includes a plurality of upper sheaves, with a derricking rope being wound around between the plurality of upper sheaves and the plurality of lower sheaves at the lower spreader, wherein: the lower spreader has a width smaller than a width of the front leg member; and the plurality of lower sheaves at the lower spreader includes at least; a first lower sheave at which the derricking rope let out from the derricking drum is first wound; a second lower sheave, disposed on a side where a fixed end of the derricking rope at which the derricking rope is fastened is located, at which the derricking rope is wound last; and a third lower sheave, disposed between the first lower sheave and the second lower sheave or at a position adjacent to either the first lower sheave or the second lower sheave, at which the derricking rope, running from an upper sheave among the plurality of upper sheaves at the upper spreader is wound so as to run toward another upper sheave at the upper spreader.

According to a second aspect of the present invention, in the construction machinery according to the first aspect, it is preferable that the lower spreader includes a plurality of third lower sheaves each identical to the third lower sheave.

According to a third aspect of the present invention, in the construction machinery according to the first or second aspect, it is preferable that the plurality of upper sheaves at the upper spreader are rotatably disposed at a support shaft parallel to the support shaft at the lower spreader.

According to a fourth aspect of the present invention, in the construction machinery according to any one of the first to third aspects, it is preferable that the lower spreader includes a pair of support frames, and the gantry includes only a friction-preventing guide roller that projects out beyond upper surfaces of the pair of support frames and spans a gap between the pair of support frames, as a guide roller for the derricking rope.

### BRIEF DESCRIPTION OF THE DRAWINGS

FIG. 1 is a side elevation of a crane achieved in an embodiment of the present invention.

FIG. 2 is an enlarged view of the crane in FIG. 1, with a boom, a counterweight, a housing, various drums and the like removed.

FIG. 3 is an enlarged view of the crane in FIG. 2 with the gantry laid down.

FIG. 4 shows how the crane body in FIG. 3 is hoisted.

FIG. 5 is a sectional view of the area V in FIG. 3 in an enlargement.

FIG. 6 is a plan view of the gantry in FIG. 2, taken along a direction A from the front side of the crane.

FIG. 7 is a rear view of the gantry in FIG. 2, taken along a direction B from the rear side of the crane.

FIG. 8 is a plan view of the gantry in FIG. 3, showing the gantry as seen from above.

FIG. 9 is a rear view of the counterweight device in FIG. 1, taken along a direction C from the rear side of the crane.

FIG. 10 schematically illustrates how the derricking rope is wound.

FIG. 11 is a side elevation illustrating an embodiment in which a counterweight self-attach/detach device is mounted at the crane according to the present invention.

FIG. 12 is a rear view of the crane shown in FIG. 11 with the counterweight device installed.

### DESCRIPTION OF PREFERRED EMBODIMENTS

### (Overall Crane Structure)

The following is a description of an embodiment of the crane according to the present invention, given in reference to drawings.

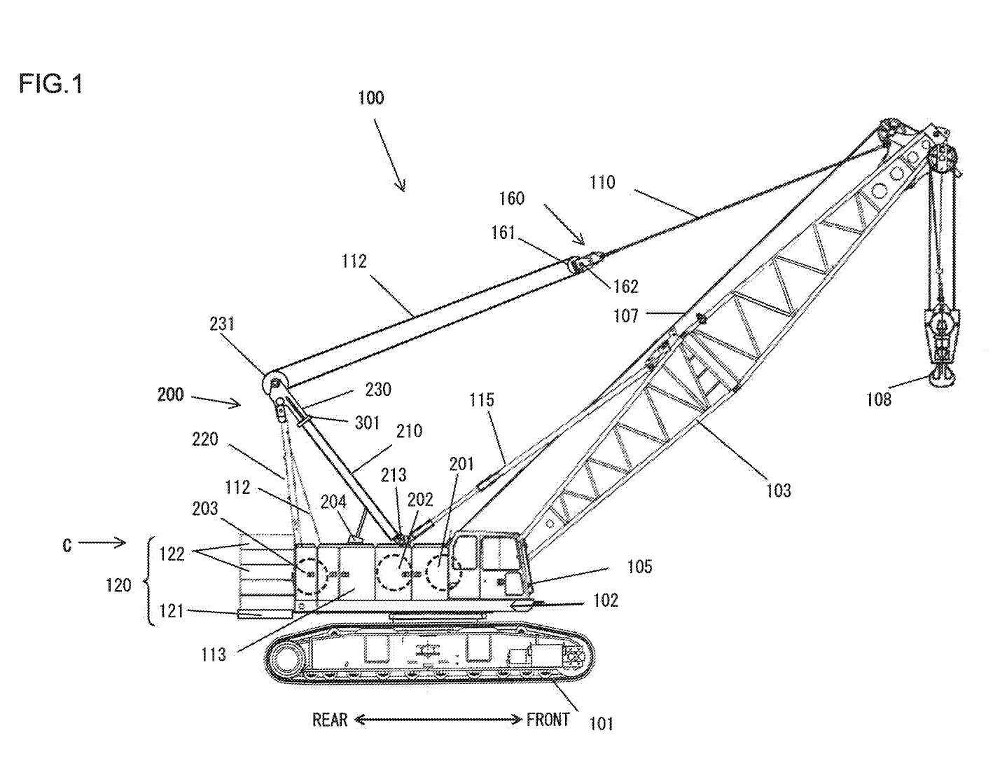

FIG. 1 is a side elevation of a crawler crane achieved in an embodiment of the present invention.

A crane 100 comprises a lower traveling superstructure 101 and a revolving frame (main frame) 102 rotatably disposed upon the traveling lower superstructure 101. An operator's cab 105 and a housing 113 are disposed on the revolving frame 102.

A boom 103, located on the front side of the revolving frame 102 at a side of the operator's cab 105, is rotatably supported at the base end portion (not shown) thereof which is axially supported at the revolving frame 102. It is to be noted that the directional terms “front” and “rear” used in the following description are defined as indicated in the figures.

A counterweight device 120 is attached to the rear end of the revolving frame 102. The counterweight device 120 includes a base plate 121 and counterweights 122 stacked over multiple stages on the base plate 121.

Three drums housed inside the housing 113 are mounted at the revolving frame 102. The three drums are disposed in the order of; a front drum 201, a rear drum 202 and a derricking drum 203, starting from the front side toward the rear side. A hook 108 is suspended from the front end of the boom 103 via a wire rope 107. One end of the wire rope 107 is fixed to the front drum 201 and thus, as the front drum 201 rotates, the wire rope 107 is taken up onto the front drum 201 or let out from the front drum 201. As the wire rope 107 is taken up or let out, the hook 108, held at the other end of the wire rope 107, is caused to move up or down relative to the front end of the boom 103.

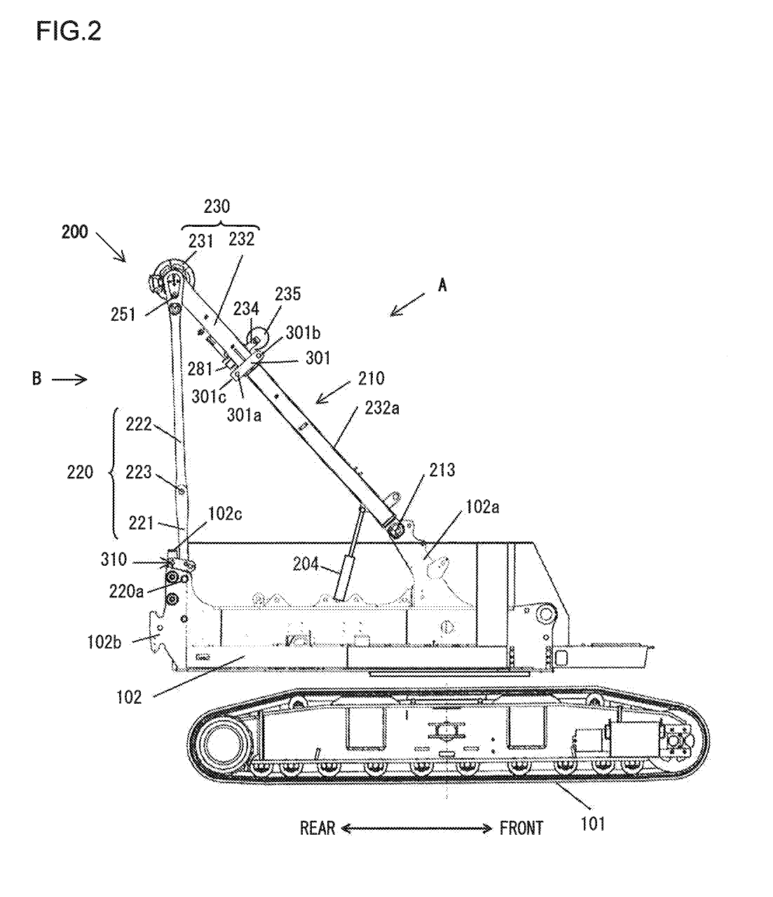

A gantry 200 is mounted on the revolving frame 102 so that it can be raised from or laid down upon the revolving frame 102. As will be explained in detail later, the gantry 200 includes a front leg member 210, a rear leg member 220 and a lower spreader 230 fixed on the upper-end side of the front leg member 210. Base end portions 213 of the front leg member 210 are rotatably linked to brackets 102a (see FIG. 2) disposed at a central area of the revolving frame 102. In addition, a base end portion 220a (see FIG. 2) of the rear leg member 220 is rotatably linked to the rear side of the revolving frame 102. Extension/contraction of a derricking hydraulic cylinder 204 causes the gantry 200 to move between an upright position and a prone position.

The lower spreader 230 includes a lower sheave group 231 made up with a plurality of lower sheaves.

An upper spreader 160 is disposed between the lower spreader 230 and the front end of the boom 103. The upper spreader 160 includes an upper sheave group 161 made up with a plurality of upper sheaves. A derricking rope 112 is wound around the upper sheave group 161 at the upper spreader 160 and the lower sheave group 231 at the lower spreader 230.

A pendant rope 110, one end of which is secured to the front end of the boom 103, is connected at its other end to the upper spreader 160.

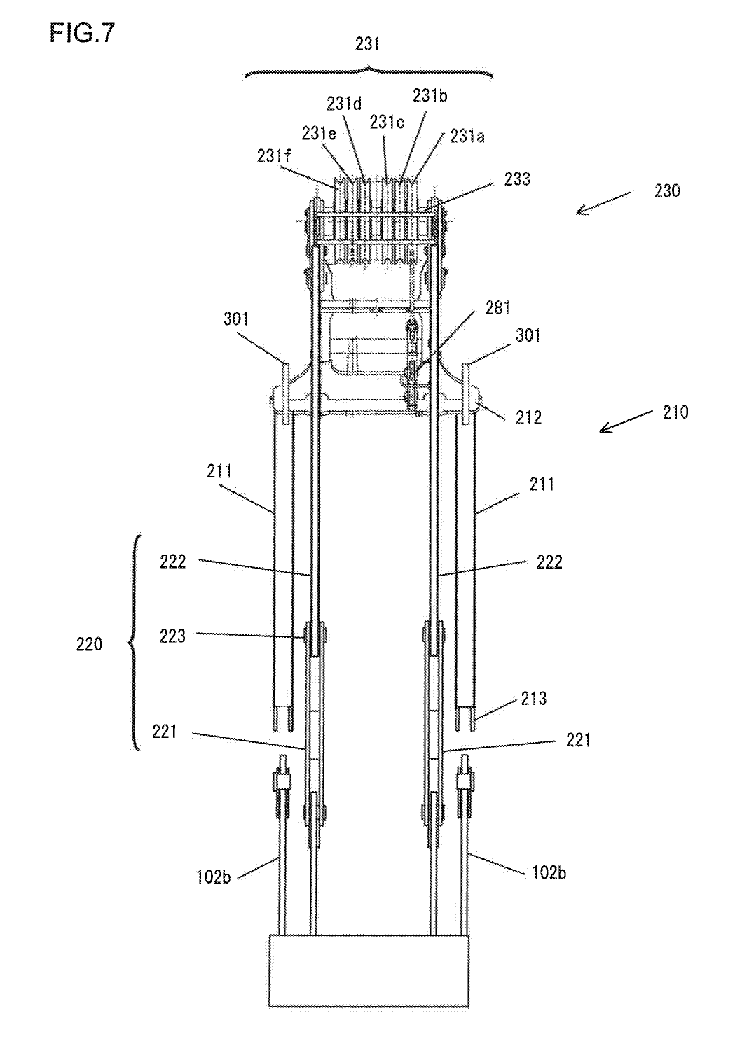

One end of the derricking rope 112 is fixed to the derricking drum 203, whereas the other end of the derricking rope 112 is linked to a load cell 281 (see FIG. 2 and FIG. 7) attached to the upper area (i.e., a member located at an upper frame 212, as will be described later) of the lower spreader 230. The end of the derricking rope 112 linked to the load cell 281 is designated as a fixed end.

As the derricking drum 203 rotates, the derricking rope 112 is taken up or let out, thereby causing the boom 103 to be raised or lowered via the derricking rope 112.

While the rear drum 202 is often utilized to elevate or lower an auxiliary hook, FIG. 1 shows it in a non-engaged state. In addition, a backstop device 115 prevents the boom 103 from becoming raised to an extent equal to or greater than a predetermined angle so as to ensure that it never swings toward the rear side of the crane.

### (Gantry)

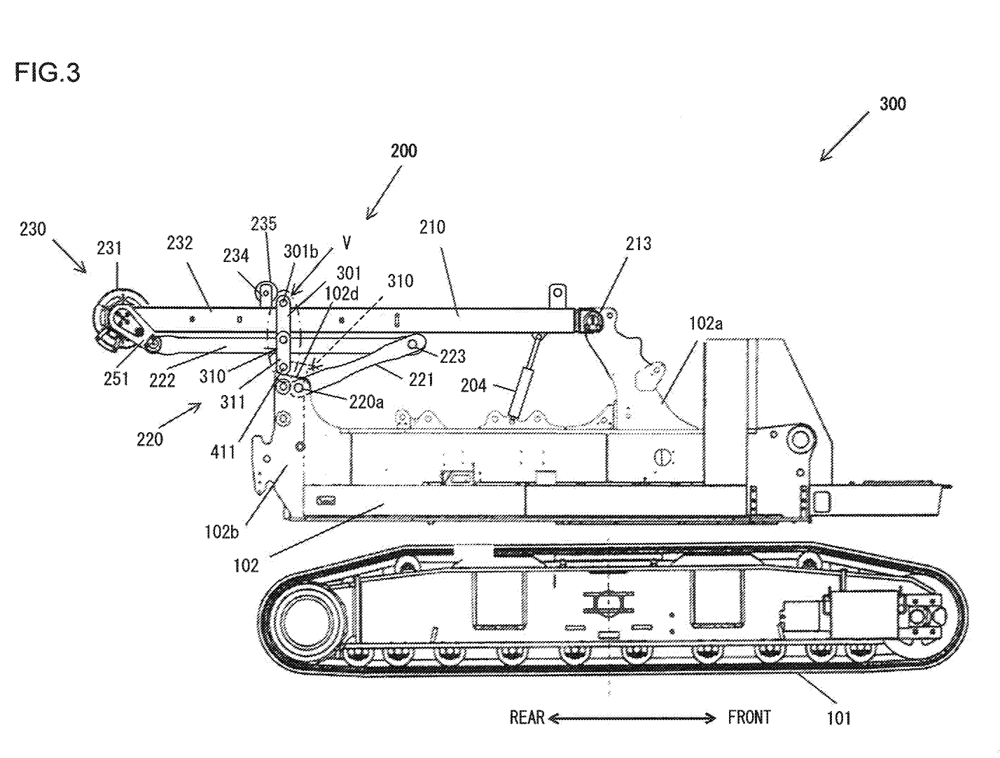

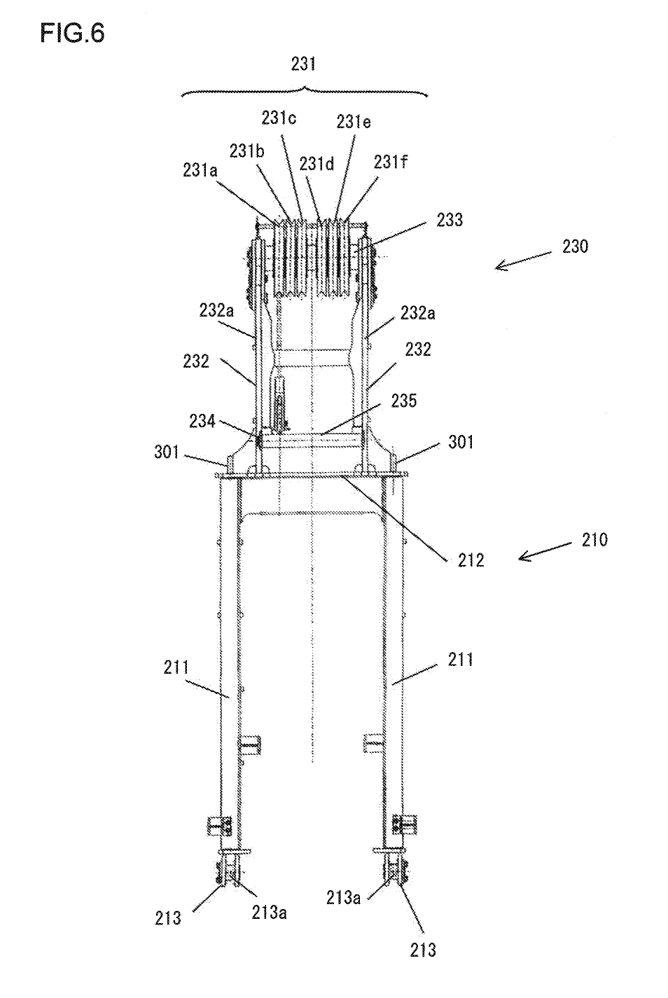

FIG. 2 is an enlarged view of the crane shown in FIG. 1 in an operating attitude, with the boom, the counterweight device, the housing and the various drums removed. FIG. 3 is an enlarged view of the crane shown in FIG. 2 in a crane-transport attitude with the gantry laid down. In addition, FIG. 6 is a plan view of the gantry shown in FIG. 2, taken along a direction A from the front side of the crane, whereas FIG. 7 is a rear view of the gantry in FIG. 2, taken along a direction B from the rear side of the crane.

The front leg member 210 in the gantry 200 includes a pair of front leg frames 211 and the upper frame 212 disposed above the front leg frames 211 and linking the pair of front leg frames 211. The base end portions 213 of the two front leg frames 211 are linked, via pins, to the brackets 102a disposed at the revolving frame 102 so as to rotatably connect the front leg member 210 to the revolving frame 102.

The lower spreader 230 includes a pair of support frames 232, a support shaft 233 mounted on the upper end side of the pair of support frames 232 so as to range between the support frames 232, and the lower sheave group 231 made up with sheaves rotatably mounted at the support shaft 233.

The lower spreader 230 further includes brackets 234 used for guide roller installation, each mounted at a top surface 232a (see FIG. 2) of one of the support frames 232 and a guide roller 235 rotatably mounted at the brackets 234 for friction prevention. The anti-friction guide roller 235 prevents the gantry 200 from coming into contact with and rubbing against another member such as the derricking rope 112.

Only the guide roller 235 disposed at the lower spreader 230 as described above is used for purposes of friction prevention in the gantry 200 achieved in the embodiment.

A pair of connecting links 301 are mounted on the upper frame 212 of the front leg member 210. The connecting links 301 are each fixed onto the upper frame 212 at the position corresponding to that of one of the front leg frames 211 through welding or by using fastening members such as bolts. In addition, the load cell 281 (see FIG. 7) is attached to a member disposed on the upper frame 212, as has been described earlier.

As shown in FIG. 2, a through hole 301a and a through hole 301b are formed in each connecting link 301. The through hole 301a is formed on the side where the revolving frame 102 is present, and the through hole 301b is formed on the opposite side.

Before the crane 100 is shipped, the boom 103, the lower traveling superstructure 101 and the counterweight device 120 are disengaged and the gantry 200 is laid down. The counterweight device 120 is mounted/dismounted by using an auxiliary crane. The connecting links 301 mentioned earlier are utilized when transporting the revolving frame 102.

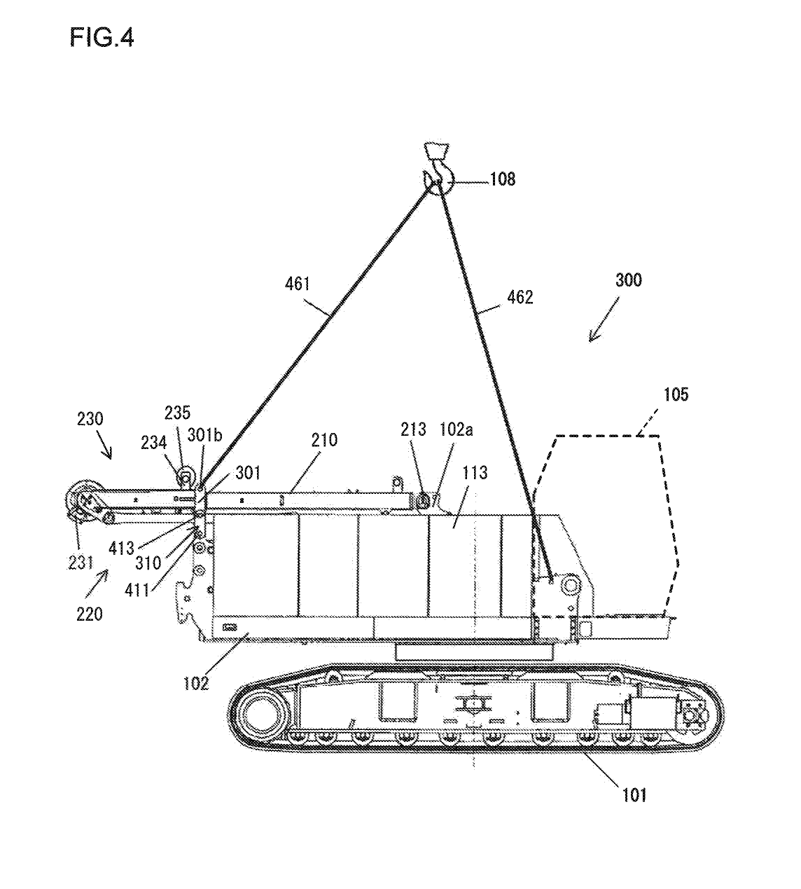

Next, in reference to FIG. 3 and FIG. 4, a body transport preparation performed to ready the body for transport before shipping the crane 100 will be described.

### (Transportation of the Body)

A linking structure 310 which links the gantry 200 to the revolving frame 102 is disposed on the rear end side of the revolving frame 102.

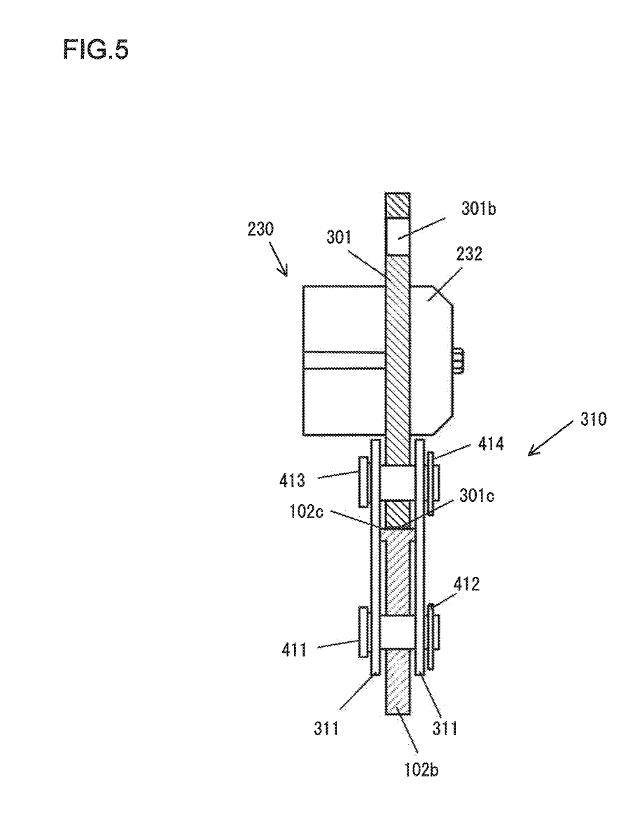

FIG. 5 shows the linking structure 310 in detail in an enlarged sectional view of the area V in FIG. 3.

The linking structure 310 is configured with brackets 102b mounted at the rear end of the revolving frame 102, one on the left side and another on the right side, a pair of coupling links (coupling members) 311 mounted on the front and rear surfaces of each of the brackets 102b, and the connecting links 301.

Two through holes are formed, one on the upper end side and the other on the lower end side, at each coupling link 311, and a shaft pin 411 is inserted through the through holes formed on the lower side of the coupling links 311 and a through hole formed at the corresponding bracket 102b. The shaft pin 411 inserted through the through holes is retained at its front end with a retainer pin 412. Thus, the two coupling links 311 are mounted at the revolving frame 102 so as to be able to rotate around the shaft pin 411.

A staged portion having a gently sloping surface 102d (see FIG. 3), inclining down from the rear side toward the front side is formed over the upper area of each bracket 102b, and the pair of coupling links 311 are set sideways so as to come into contact with the sloping surface of the staged portion, as indicated by the dotted line in FIG. 3, except for when the body is being transported.

Before the crane 100 is shipped, it is disassembled and the boom 103, the traveling lower superstructure 101, the counterweight device 120 and the like are disengaged from the revolving frame 102. In addition, the pendant rope 110 and the upper spreader 160 are dismounted. FIG. 3 shows the gantry 200 in the retracted state in an enlarged view. While the crane is transported with the front drum 201, the rear drum 202, the derricking drum 203 and the like mounted at the revolving frame 102, FIG. 3 does not show these members, so as to illustrate the gantry 200 in the retracted state clearly.

In the following description, the crane 100, having been disassembled and readied for transportation by disengaging the boom 103, the traveling lower superstructure 101, the counterweight device 120 and the like from the revolving frame 102, will be referred to as a body 300. It is to be noted that the term “body” 300 used in this description simply refers to a crane in the transport-ready state, which may include different members mounted at the revolving frame 102. Namely, the term “body” 300 is defined as the revolving frame 102 ready to be hoisted with hoisting ropes.

FIG. 2 shows that the rear leg member 220 includes a lower member 221 and an upper member 222 rotatably linked to the lower member 221 via a support shaft 223. The upper end of the upper member 222 is rotatably linked to an end of a linking plate 251, and the other end of the linking plate is rotatably attached to the lower spreader 230.

The gantry 200, taking on the operating attitude shown in FIG. 2, is laid down to assume the retracted state in FIG. 3 by contracting the derricking hydraulic cylinder 204. As the derricking hydraulic cylinder 204 contracts, the front leg member 210 rotates, centered on its base end portions 213, along the counterclockwise direction in FIG. 3. The rotation of the front leg member 210 causes, via the linking plate 251 and the upper member 222, a clockwise rotation of the lower member 221. As the upper member 222 and the lower member 221 pivot on the support shaft 223, they rotate relative to each other and thus, the retracted state shown in FIG. 3 is assumed.

When the gantry 200 is laid down in the retracted state as shown in FIG. 3, a lower end 301c (see FIG. 2) of each connecting link 301 is set at a position at which it is held between the pair of coupling links 311. In addition, the lower end 301c of the connecting link 301 is in contact with an upper end surface 102c (see FIG. 2 and FIG. 5) of the corresponding bracket 102b disposed at the revolving frame 102. The gantry 200 is thus held at this height. In this condition, the through holes located on the upper side of the coupling links 311 are aligned with the through hole 301a (see FIG. 2) at the connecting link 301. This alignment can be performed by adjusting the positions of the coupling links 311, i.e., by rotating them around the shaft pin 411. Once the alignment is completed, a coupling pin 413 is inserted through the through holes formed on the upper side of the coupling links 311 and the through hole 301a formed at the connecting link 301. The coupling pin 413 having been inserted through the through holes is then retained at its front end with a retainer pin 414. FIG. 5 shows the linking structure in this state.

In this condition, the gantry 200, set in the refracted state, is locked to the revolving frame 102 via the connecting links 301 and the corresponding pairs of coupling links 311. It is to be noted that for better ease of operation, the retainer pins 414 should each be latched and held at the corresponding coupling pin 413 when the connecting links 301 are not linked with the coupling links 311.

The body 300 in this retracted state is hoisted with a hoisting crane, as illustrated in FIG. 4, and loaded onto a transport vehicle.

A method adopted when hoisting the body 300 with a hoisting crane will be described next.

A hoisting rope 461, with one end thereof held at the hook 108 of the hoisting crane, is attached at the other end thereof at the through holes 301b of the connecting links 301. More specifically, the front end of a hanging clamp (not shown) is inserted through the through holes 301b at the connecting links 301 and the front end of the hoisting rope 461 is fastened to the hanging clamp. In addition, a hoisting rope 462, with one end thereof held at the hook 108 of the hoisting crane, is attached at the other end thereof, to an area of the revolving frame 102 where the base end of the boom 103 is axially supported.

In this condition, the body 300 is hoisted by raising the hook 108.

As has been described, the gantry 200 in the embodiment is linked to the revolving frame 102 via the connecting links 301 disposed at the upper end surface of the upper frame 212 constituting part of the front leg member 210 and the coupling links 311 coupled with the connecting links 301. In this state, the hoisting rope 461 is attached to the connecting links 301. The distance between the base end portions 213 of the front leg member 210 and the corresponding connecting links 301 is smaller than the distance to the front end of the gantry 200. This means that the extent to which the shape of the gantry 200 may change can be reduced compared to the extent of shape change which may be caused when the hoisting rope 461 is attached to the front end of the gantry 200.

Next, the optimal winding structure with which the derricking rope 112 is wound around the lower spreader 230 and the upper spreader 160 will be described.

### (Derricking Rope Winding Structure)

As shown in FIG. 6, the lower spreader 230 of the gantry 200 is mounted at the front leg member 210. The lower spreader 230 is mounted by locking the lower ends of the pair of support frames 232 in the lower spreader 230 to the upper frame 212 of the front leg member 210.

The width of the lower spreader 230 is less than the width of the front leg member 210. In other words, the distance between the pair of support frames 232 in the lower spreader 230 is less than the distance ranging between the pair of front leg frames 211 in the front leg member 210.

A plurality of lower sheaves (six sheaves in the example presented in FIG. 6) 231a through 231f are rotatably supported at the support shaft 233 of the lower spreader 230 so as to be allowed to rotate around the support shaft 233.

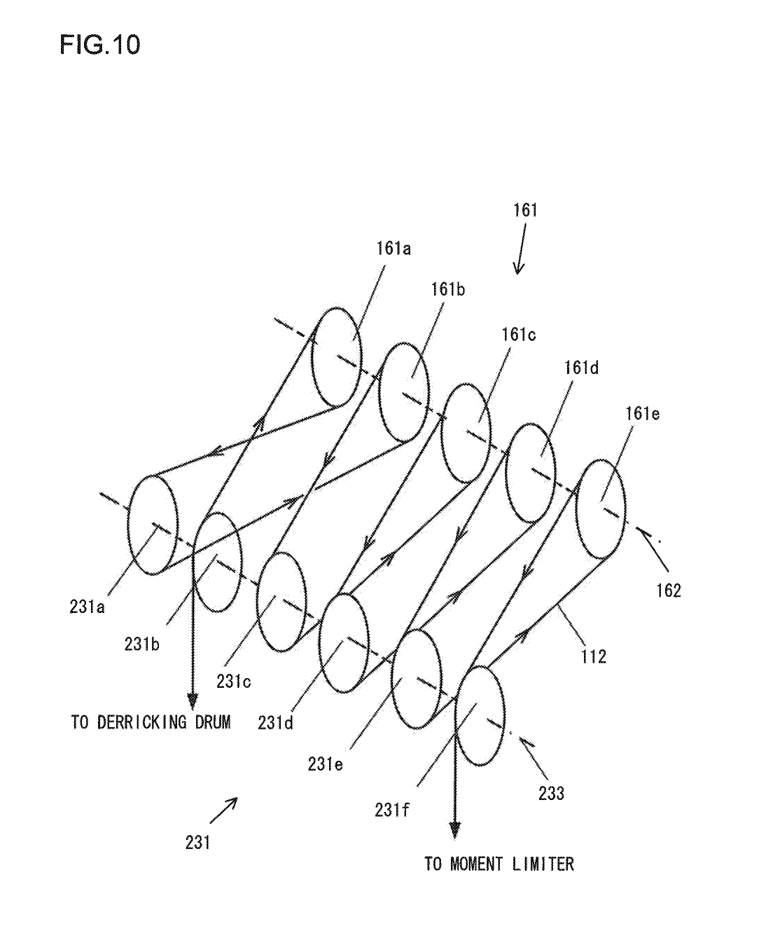

In addition, a plurality of upper sheaves (five sheaves in this embodiment) 161a through 161e (see FIG. 10) are rotatably supported at a support shaft 162 (see FIG. 1) of the upper spreader 160 so as to be allowed to rotate around the support shaft 162.

The support shaft 233 at the lower spreader 230 is disposed to range parallel to the rotating shaft (not shown) of the derricking drum 203. It is also disposed parallel to the support shaft 162 at the upper spreader 160.

In this positional arrangement, the lower sheaves 231a through 231f and the upper sheaves 161a through 161e are each disposed so as to range along the top/bottom direction running perpendicular to the support shaft 233 and the support shaft 162. Namely, the lower sheaves are the type of sheaves often referred to as vertical sheaves.

FIG. 10 schematically illustrates how the derricking rope 112 is wound through the lower sheaves 231a through 231f and the upper sheaves 161a through 161e.

The derricking rope 112 let out from the derricking drum 203 is first wound around the lower sheave 231b disposed at the second position counting from one end of the lower sheave group 231. The derricking rope 112 wound around the lower sheave 231b is then wound around the upper sheave 161a disposed at the first position in the upper sheave group 161 at one end thereof on the side where the one end of the lower sheave group 231 is located. The derricking rope 112 wound around the upper sheave 161a is then wound around the lower sheave 231a disposed at the first position on the side where the one end of the lower sheave group 231 is located. The derricking rope 112 wound around the lower sheave 231a is next wound around the upper sheave 161b disposed at the second position counting from the side on which the one end of the upper sheave group 161 is located. The derricking rope 112 wound around the upper sheave 161b is next wound around the lower sheave 231c disposed at the third position counting from the side on which the one end of the lower sheave group 231 is located. The derricking rope 112 wound around the lower sheave 231c is next wound around the upper sheave 161c disposed at the third position counting from the side on which the one end of the upper sheave group 161 is located.

Subsequently, the derricking rope 112 is wound in sequence, alternately around a sheave belonging to the lower sheave group 231 and a sheave belonging to the upper shave group 161 so that it is sequentially wound around sheaves disposed next to each other on the side where the other ends of the lower sheave group and the upper sheave group are located. In other words, the derricking rope 112 having been wound around the upper sheave 161c is wound around the remaining sheaves in the order of; the lower sheave 231d→the upper sheave 161d→the lower sheave 231e→the upper sheave 161e→the lower sheave 231f. The derricking rope 112 having been wound around the lower sheave 231f is then secured to the load cell 281 which functions as a moment limiter.

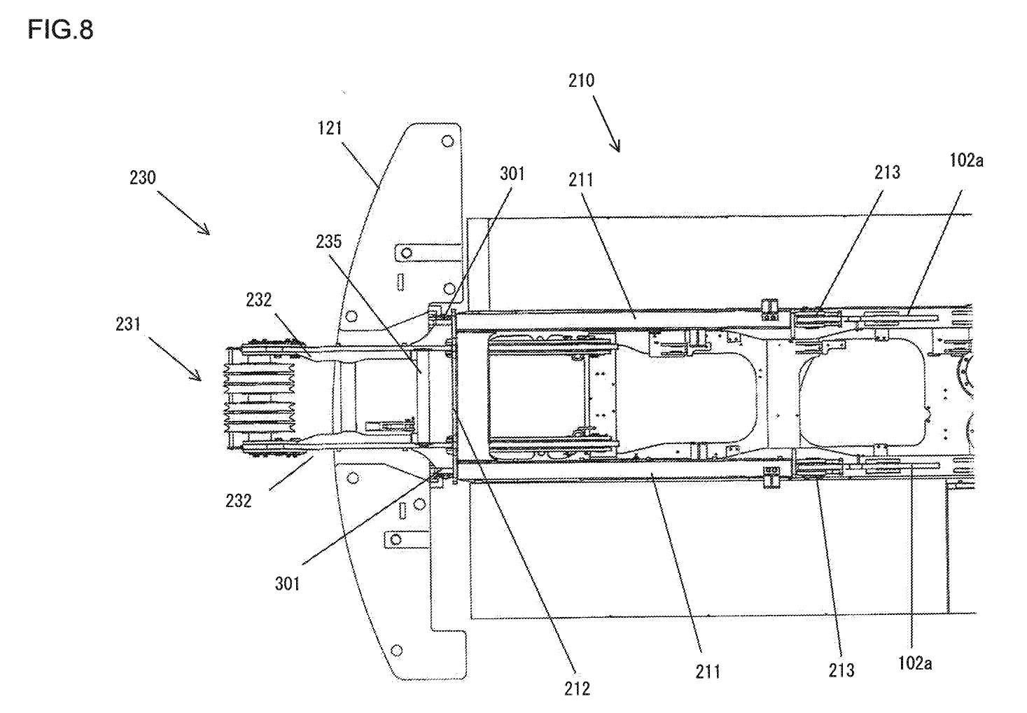

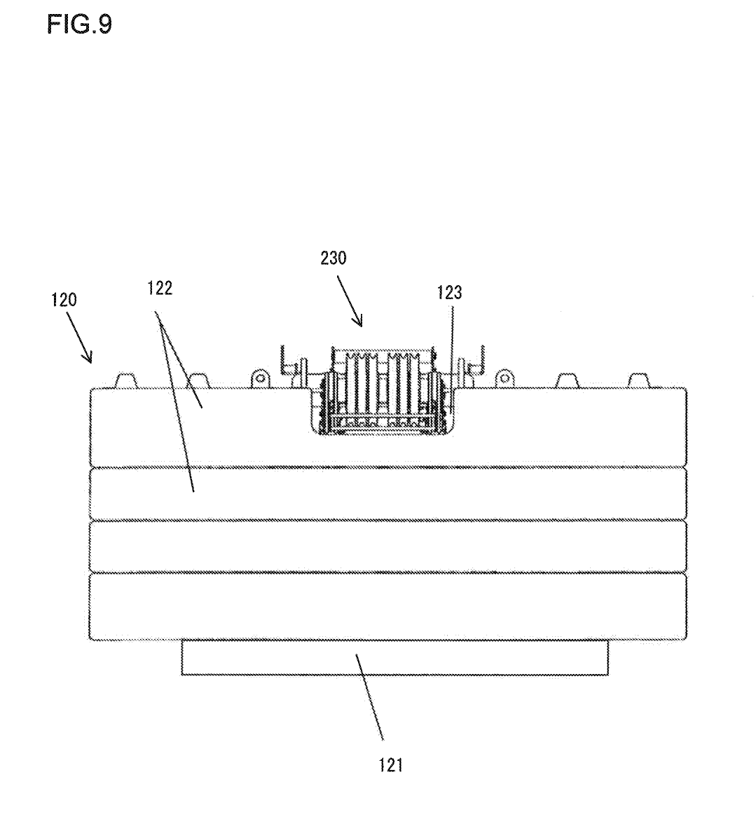

FIG. 8 is a plan view of the gantry in FIG. 3 taken from a point above the gantry, whereas FIG. 9 is a rear view of the counterweight device shown in FIG. 1, taken along a direction C from the rear side of the crane.

When the gantry 200 is in the retracted state, the lower spreader 230 is placed over the counterweight device 120, as shown in FIG. 8. It is to be noted, however, that counterweights 122 in the counterweight device 120 are stacked to a position achieving a greater height than the lower spreader 230 in the refracted state, as shown in FIG. 9, so as to achieve greater weight.

For this reason, in order to ensure that the counterweight device does not interfere with the lower spreader 230, a recessed portion 123 is formed on the top side of a counterweight 122.

In the embodiment, the lower sheaves 231a through 231f at the lower spreader 230 are each disposed to range along the top/bottom direction running perpendicular to the support shaft 233. In other words, there is no horizontal sheave, which is oriented along the horizontal direction parallel to the support shaft 233, among the lower sheaves. For this reason, the width of the lower spreader 230 is less than the width of the front leg member 210.

As a result, the recessed portion 123 at the counterweight 122, too, is allowed to assume a smaller width. This means that greater weight can be provided with the counterweight device 120, compared to the weight achieved when the width of the lower spreader 230 matches the width of the gantry 200.

As described above, the lower sheaves at the lower spreader 230 do not include any horizontal sheave oriented along the horizontal direction running parallel to the support shaft 233. Thus, there is no need to install a guide and a roller for purposes of friction prevention, which would project out along the direction in which the width of the gantry 200 ranges, at the gantry 200. As a result, since these friction-preventing members are not required, the weight of the gantry can be reduced and, furthermore, the manufacturing cost for the gantry can be reduced.

By reducing the width of the lower spreader 230, various advantages can be achieved as described above.

(Application in Conjunction with a Counterweight Equipped with a Self-Attach/Detach Device)

In the embodiment described above, the counterweight device 120 is mounted/dismounted at/from the crane 100 with an auxiliary crane.

However, the present invention may be adopted in a crane 100 that includes a self-attach/detach device-equipped counterweight.

The term “self-attach/detach device-equipped counterweight” is used to refer to a counterweight device 120 equipped with a pair of cylinders that make it possible to mount/dismount the counterweight device 120 at/from the revolving frame 102 without having to use an auxiliary crane.

The concept of mounting/dismounting the self-attach/detach device-equipped counterweight will be described next.

On the rear end side of the revolving frame, an alignment notch and a first opening portion through which a pin used to attach a linking frame of the counterweight is inserted, are formed. A pair of hydraulic cylinders are connected to the base plate of the counterweight device and the linking frame, which moves up/down as the hydraulic cylinders extend/contract is linked to each hydraulic cylinder. At the linking frame, a pin that comes into contact with the notch and a second opening portion, which corresponds to the first opening portion at the revolving frame, are formed. The pin and the second opening portion are present at positions offset relative to the extension/contraction axes of the hydraulic cylinders.

As the hydraulic cylinders extend, the pin at the counterweight device comes into contact with the notch at the revolving frame. As the hydraulic cylinders further extend, the linking frame rotates with the pin acting as the fulcrum, until the second opening portion becomes aligned with the first opening portion. In this state, a mounting pin is inserted through the first opening portion and the second opening portion.

The individual hydraulic cylinders are then made to contract, thereby elevating the base plate. A bracket having a third through hole formed therein is locked to the base plate. Once the base plate moves up to a position at which the third through hole is aligned with a fourth through hole formed at the revolving frame, a locking pin is inserted through the third through hole and the fourth through hole.

It is to be noted that the concept of the counterweight mounting method is simply described in broad terms above and that Japanese laid open patent publication No. 2011-190083, for instance, should be referred to for further details.

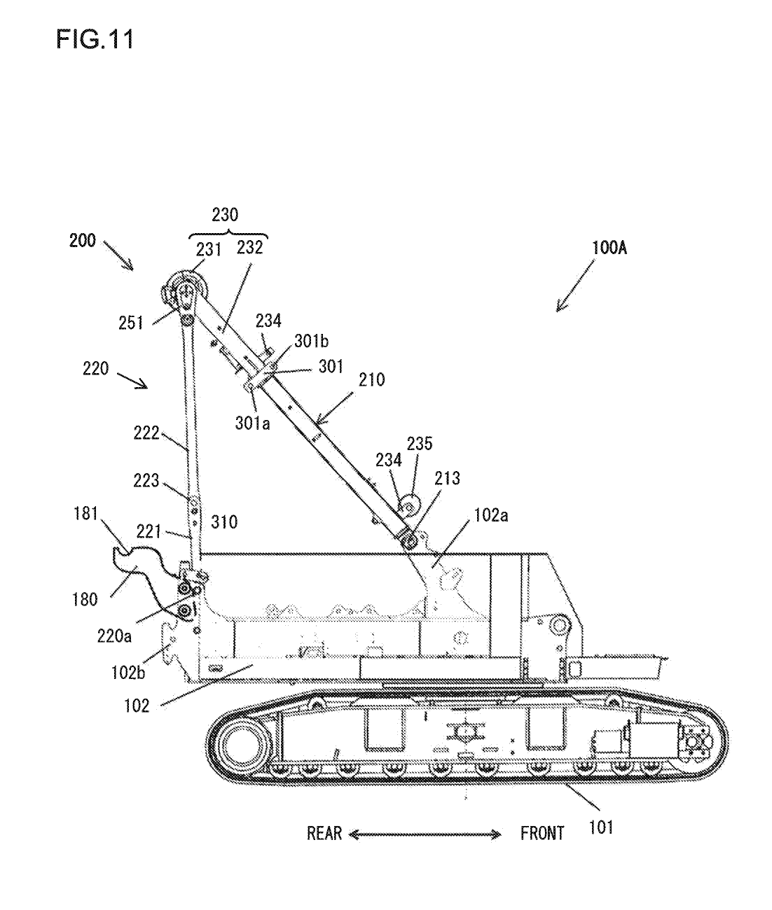

FIG. 11 shows a pair of hooking brackets 180 is attached to the rear end of the revolving frame 102 configuring a crane 100A that includes a self-attach/detach device-equipped counterweight. Hooks 181 are formed at each hooking bracket 180.

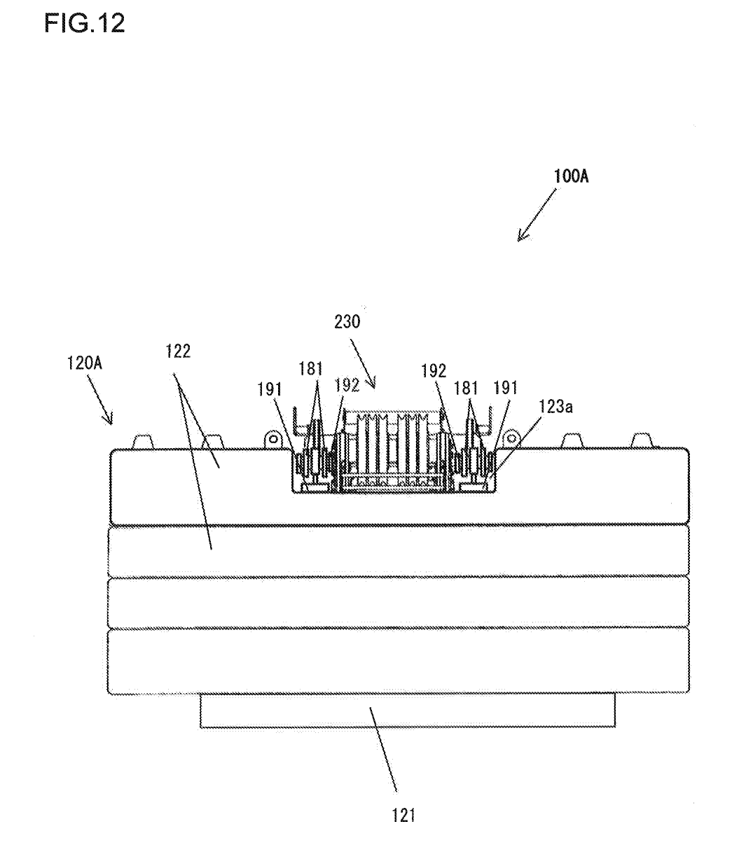

FIG. 12 illustrates how a counterweight device 120A is mounted at the hooking brackets 180.

A pair of hydraulic cylinders 191 are connected at a base plate 121.

The pair of hydraulic cylinders 191 are extended so as to hook pins 192, which are attached at the front ends of the individual hydraulic cylinders 191, at the hooks 181 at the hooking brackets 180, and then the pair of hydraulic cylinders 191 are caused to contract. Through this process, the counterweight device 120A is mounted at the revolving frame 102. It is to be noted that although not shown, brackets (not shown in figures) disposed at the revolving frame 102 and the base plate 121 are linked with each other via a locking pin inserted in through holes formed at the two members after the through holes are aligned by contracting the hydraulic cylinders.

The self-attach/detach device-equipped counterweight device 120A includes the pair of hydraulic cylinders. This means that if the gantry 200 has a significant width, the width of a recessed portion 123a formed at the counterweight device to provide clearance for the gantry 200, too, is bound to be large, and under such circumstances, the counterweight device will not be able to carry much weight. For this reason, the self-attach/detach device-equipped counterweight device 120A cannot be installed in a crane with the gantry 200 in the related art. While a self-attach/detach device comprising hydraulic cylinders and the like may be disposed at the body 300, the body 300 of such a crane is bound to be heavy, which will make it difficult to disassemble the crane and transport the body 300.

It is to be noted that since other structural elements of the crane 100A are similar to those of the crane 100, the same reference numerals are assigned to the corresponding members so as to preclude the necessity for a repeated explanation thereof.

In the crane 100A, the lower spreader 230 in the gantry 200 is allowed to assume a smaller width and thus, the pair of hydraulic cylinders can be disposed over a smaller distance from each other. As a result, the width of the recessed portion 123a formed at the counterweight 122, too, can be reduced, as illustrated in FIG. 12. Through these measures, it becomes possible to mount the self-attach/detach device-equipped counterweight device 120A even at a crane that includes the gantry 200.

The following advantages are achieved through the embodiments described above.

(1) The lower sheaves 231a through 231f at the lower spreader 230 are all vertical sheaves oriented along the top/bottom direction. In other words, there is no horizontal sheave oriented along the direction parallel to the support shaft 233. As a result, the width of the lower spreader 230 can be set smaller than that of the lower spreader in a gantry that includes lower sheaves set with an orientation parallel to the support shaft 233.

(2) It is necessary for a gantry that includes lower sheaves oriented parallel to the support shaft 233 to have a structural member referred to as a hanger, at which the lower sheaves are mounted. The manufacturing process for producing this hanger can be eliminated in the embodiment. In addition, since materials other than those used to constitute the sheaves, i.e., the materials to constitute the hanger are not required, lighter weight is achieved and, at the same time, the manufacturing cost can be reduced.

(3) Since the lower sheaves at the lower spreader 230 do not include any horizontal sheave oriented along the horizontal direction running parallel to the support shaft 233, there is no need to install a guide and a roller for purposes of friction prevention at the front leg member of the gantry 200. As a result, since these friction-preventing members are not required, the weight of the gantry can be reduced and, furthermore, the manufacturing cost for the gantry can be reduced.

(4) Since the lower spreader 230 is allowed to assume a width smaller than the width of the lower spreader in a gantry that includes horizontal sheaves oriented parallel to the support shaft 233, the width of the recessed portion 123, formed at the counterweight 122 so as to avoid interference with the gantry, can be reduced. As a result, the counterweight device 120 is able to carry greater weight.

(5) Since the width of the lower spreader 230 is reduced, the distance between the pair of hydraulic cylinders at the self-attach/detach device-equipped counterweight device 120A, too, can be reduced. Thus, the self-attach/detach device-equipped counterweight device 120A can be mounted even at the crane 100A, which includes a gantry.

It is to be noted that the embodiments described above further achieve the following advantages.

(6) The hoisting rope 461 is attached to the connecting links 301 disposed at the upper end surface of the front leg member 210. The connecting links 301 are linked to the revolving frame 102 via the coupling links 311. This means that the extent to which the shape of the gantry 200 may change can be reduced compared to the extent of shape change which may be caused in the method in which the hoisting rope 461 is attached to the front end of the gantry 200.

(7) The connecting links 301 are disposed at positions close to the top of the housing 113 and thus, operating personnel are able to attach the hoisting rope 461 to the connecting links 301 by climbing onto the housing 113 and are able to perform mounting work efficiently. In the related art, the position of the front end of the gantry to be attached to the hoisting rope 461 is offset relative to the position of the housing 113 along the direction running to the front side/rear side of the crane 100, and thus, the hoisting rope 461 needs to be attached by using a step ladder or the like.

It is to be noted that while six sheaves are disposed at the lower spreader 230 in the embodiment described earlier, the present invention is not limited to this example.

Namely, as long as the lower sheaves at the lower spreader include the following three lower sheaves, any number of lower sheaves may be installed at the lower spreader:

(i) a first lower sheave 231b at which the derricking rope 112 let out from the derricking drum 203 is first wound,

(ii) a second lower sheave 231f, disposed on a side where the fixed end of the derricking rope at which the derricking rope 112 is fastened is located, at which the derricking rope 112 is wound last, and

(iii) a third lower sheave disposed between the first lower sheave 231b and the second lower shave 231f or at a position adjacent to either the first lower sheave or the second lower sheave, at which the derricking rope, running from an upper sheave among the plurality of upper sheaves 161a through 161e at the upper spreader is wound so as to run toward another upper sheave at the upper spreader 160.

The gantry 200 achieved in the embodiments described earlier includes a single guide roller 235 used for purposes of friction prevention, which is disposed at the lower spreader 230. However, a greater number of friction preventing guide rollers may be disposed, or a friction preventing guide roller may be disposed at the front leg member 210.

In addition, while the construction machinery having a foldable gantry with an integrated lower spreader, at which a derricking rope is wound between the lower spreader and an upper spreader, is embodied as cranes in the description provided above, the present invention is not limited to this example and may be adopted in another type of construction machinery such as a pile driver.

In addition, the crane according to the present invention allows for numerous variations within the scope of the invention.

In the embodiments of the present invention described above, the third lower sheave, which corresponds to an intermediate sheave in the related art, is disposed coaxially to the first and second lower sheaves and rotates around the common axis. As a result, the lower spreader at the gantry is allowed to assume a smaller width.

What is claimed is:

1. A construction machinery, comprising:
a derricking drum disposed at a main frame;
a gantry that includes a front leg member, a lower spreader laterally disposed at an upper end of the front leg member with a plurality of lower sheaves axially supported at a support shaft, and a rear leg member with an upper end of the rear leg member linked to the support shaft, and is foldably disposed at the main frame; and
an upper spreader that includes a plurality of upper sheaves, with a derricking rope being wound around between the plurality of upper sheaves and the plurality of lower sheaves at the lower spreader, wherein:
the lower spreader has a width smaller than a width of the front leg member; and
the plurality of lower sheaves at the lower spreader includes at least;
a first lower sheave at which the derricking rope let out from the derricking drum is first wound;
a second lower sheave, disposed on a side where a fixed end of the derricking rope at which the derricking rope is fastened is located, at which the derricking rope is wound last; and
a third lower sheave, disposed between the first lower sheave and the second lower sheave or at a position adjacent to either the first lower sheave or the second lower sheave, at which the derricking rope, running from an upper sheave among the plurality of upper sheaves at the upper spreader is wound so as to run toward another upper sheave at the upper spreader.

2. A construction machinery according to claim 1, wherein:
the lower spreader includes a plurality of third lower sheaves each identical to the third lower sheave.

3. A construction machinery according to claim 1, wherein:
the plurality of upper sheaves at the upper spreader are rotatably disposed at a support shaft parallel to the support shaft at the lower spreader.

4. A construction machinery according to claim 1, wherein:
the lower spreader includes a pair of support frames, and the gantry includes only a friction-preventing guide roller that projects out beyond upper surfaces of the pair of support frames and spans a gap between the pair of support frames, as a guide roller for the derricking rope.

5. A construction machinery according to claim 2, wherein:
the plurality of upper sheaves at the upper spreader are rotatably disposed at a support shaft parallel to the support shaft at the lower spreader.

6. A construction machinery according to claim 2, wherein:
the lower spreader includes a pair of support frames, and the gantry includes only a friction-preventing guide roller that projects out beyond upper surfaces of the pair of support frames and spans a gap between the pair of support frames, as a guide roller for the derricking rope.

7. A construction machinery according to claim 3, wherein:
the lower spreader includes a pair of support frames, and the gantry includes only a friction-preventing guide roller that projects out beyond upper surfaces of the pair of support frames and spans a gap between the pair of support frames, as a guide roller for the derricking rope.

8. A construction machinery according to claim 5, wherein:
the lower spreader includes a pair of support frames, and the gantry includes only a friction-preventing guide roller that projects out beyond upper surfaces of the pair of support frames and spans a gap between the pair of support frames, as a guide roller for the derricking rope.
